(19) United States
(12) Patent Application Publication
(10) Pub. No.: US 2018/0040286 A1
(43) Pub. Date: Feb. 8, 2018

(54) DISPLAY DRIVER CIRCUIT BOARD, DRIVING METHOD THEREOF, AND DISPLAY DEVICE

(71) Applicant: SHANGHAI AVIC OPTO ELECTRONICS CO., LTD., SHANGHAI (CN)

(72) Inventors: Zhengyuan HUANG, SHANGHAI (CN); Xupeng WANG, SHANGHAI (CN); Shuquan FAN, SHANGHAI (CN); Shanrong WANG, SHANGHAI (CN)

(73) Assignee: SHANGHAI AVIC OPTO ELECTRONICS CO., LTD., SHANGHAI (CN)

(21) Appl. No.: 15/786,571

(22) Filed: Oct. 17, 2017

(30) Foreign Application Priority Data
May 25, 2017 (CN) 201710381087.5

(51) Int. Cl. G09G 3/36; G09F 19/02; G02F 1/1333; F16H 19/06

(52) U.S. Cl. CPC G09G 3/3655; F16H 19/06; G09F 19/02; G02F 1/133305; G09G 3/3648; G09G 3/3696; G09G 2320/0247

(57) ABSTRACT

Embodiments of the disclosure provide a display driver circuit board, a driving method of the same, and a display device, where a display refresh frequency detection unit and a common voltage pre-storage and compensation unit are added to the display driver circuit board, so that the display refresh frequency detection unit can detect a display refresh frequency of a frame start signal output by a timing control circuit, and output the detected display refresh frequency to a common voltage pre-storage and compensation unit, and thereafter the common voltage pre-storage and compensation unit can determine a common voltage corresponding to the display refresh frequency output by the display refresh frequency detection unit according to a pre-stored correspondence relationship between respective display refresh frequencies and respective common voltages, and control a power source management circuit to output the common voltage corresponding to the display refresh frequency.

### RELATED APPLICATIONS

This application claims priority to Chinese Patent Application No. 201710381087.5, filed May 25, 2017, the content of which is hereby incorporated by reference in its entirety.

### FIELD

The present disclosure relates to the field of display technologies, and particularly to a display driver circuit board, a driving method thereof, and a display device.

### BACKGROUND

At present, a liquid crystal display panel as illustrated in FIG. 1 comprises a display panel, a display driver circuit board PCB connected with the display pane Panel, and a plurality of source driver chips IC1, IC2, IC3, and IC4 bound on an edge frame of the display panel by a Chip On Film (COF), where the display driver circuit board PCB includes a timing control circuit (Tcon) and a power source management circuit (DC-DC); the timing control circuit is configured to output a frame start signal (STV) A to the respective source driver chips IC1, IC2, IC3, and IC4 at a preset display refresh frequency; and the power source management circuit is configured to output fixed common voltage B to the respective source driver chips IC1, IC2, IC3, and IC4 after determining the optimum common voltage (Vcom) according to a characteristic of the display panel.

As liquid crystal display panels with high definition (UHD and WQ+) and a large size (12′ to 40′) are being developed constantly, power consumption of the liquid crystal display panels are also being increased, so there are a number of power consumption lowering methods emerging. For example, static pictures can be displayed by lowering the display refresh frequency from 60 Hz as illustrated in FIG. 2A to 45 Hz as illustrated in FIG. 2B, and inserting a media stream storage frame between two frames of pictures to thereby lower power consumption. However the uniformity of the characteristic of the display pane Panel may be less stabilized, and a factor of flicker may be degraded by 5 dB to 10 dB due to the lower display refresh frequency, thus significantly degrading the display quality of the display panel in a low power-consumption application.

In view of this, it is highly desirable to address the problem of a degraded factor of flicker in the display panel being used when frequency is changed.

### SUMMARY

Embodiments of the disclosure provide a display driver circuit board, a driving method thereof, and a display device so as to address the problem of a degraded factor of flicker in the display panel being used when frequency is changed in the related art.

In an aspect, an embodiment of the disclosure provides a display driver circuit board including: a timing control circuit, a power source management circuit, a display refresh frequency detection unit, and a common voltage pre-storage and compensation unit, wherein the timing control circuit is configured to output a frame start signal at a preset display refresh frequency, the display refresh frequency detection unit is electrically connected with the timing control circuit and the common voltage pre-storage and compensation unit, and configured to detect the display refresh frequency of the frame start signal output by the timing control circuit, and to output the detected display refresh frequency to the common voltage pre-storage and compensation unit; and the common voltage pre-storage and compensation unit is electrically connected with the power source management circuit, and configured to determine common voltage corresponding to the display refresh frequency output by the display refresh frequency detection unit according to a pre-stored correspondence relationship between respective display refresh frequencies and respective common voltages, and to control the power source management circuit to output the common voltage corresponding to the display refresh frequency.

In another aspect, an embodiment of the disclosure further provides a display device including a display panel, and the display driver circuit board according to the embodiment of the disclosure, connected with the display panel.

In another aspect, an embodiment of the disclosure further provides a method for driving a display driver circuit board, the method including

outputting, by a timing control circuit, a frame start signal at a preset display refresh frequency, and detecting, by a display refresh frequency detection unit, the display refresh frequency of the frame start signal output by the timing control circuit, and outputting the detected display refresh frequency to a common voltage pre-storage and compensation unit; and determining, by the common voltage pre-storage and compensation unit, a common voltage corresponding to the display refresh frequency output by the display refresh frequency detection unit according to a pre-stored correspondence relationship between respective display refresh frequencies and respective common voltages, and controlling the power source management circuit to output the common voltage corresponding to the display refresh frequency.

Certain advantageous effects of the disclosure may be as follows:

In the display driver circuit board, the driving method of the same, and the display device according to the embodiments of the disclosure, the display refresh frequency detection unit and the common voltage pre-storage and compensation unit are added to the display driver circuit board, so that the display refresh frequency detection unit can detect the display refresh frequency of the frame start signal output by the timing control circuit, and output the detected display refresh frequency to the common voltage pre-storage and compensation unit, and thereafter the common voltage pre-storage and compensation unit can determine the common voltage corresponding to the display refresh frequency output by the display refresh frequency detection unit according to the pre-stored correspondence relationship between respective display refresh frequencies and respective common voltages, and control the power source management circuit to output the common voltage corresponding to the display refresh frequency, so that the display driver circuit board can adjust in real time the output common voltage according to the varying display refresh frequency to thereby guarantee the output common voltage to be the optimum common voltage matching the display refresh frequency, thus facilitating an improvement in stabilized uniformity of the display panel, and addressing a factor of flicker so as to improve the display quality of the display panel, and improve user experience.

### BRIEF DESCRIPTION OF THE DRAWINGS

FIG. 1 is a schematic structural diagram of a display panel in the related art;

FIG. 2A is a schematic diagram of displaying at a display refresh frequency of 60 Hz in the related art;

FIG. 2B is a schematic diagram of displaying at a lower display refresh frequency of 45 Hz in the related art;

FIG. 3 is a schematic structural diagram of a display driver circuit board according to an embodiment of the disclosure;

FIG. 4A to FIG. 4D are four other schematic structural diagrams of a display driver circuit board according to embodiments of the disclosure;

FIG. 5A to FIG. 5C are three other schematic structural diagrams of a display driver circuit board according to embodiments of the disclosure;

FIG. 6 is a schematic circuit structural diagram of a display driver circuit board according to an embodiment of the disclosure;

FIG. 7 is a flow chart of a driving method of a display driver circuit board according to an embodiment of the disclosure;

FIG. 8 is a schematic structural diagram of a display device according to an embodiment of the disclosure;

FIG. 9 is a schematic structural diagram of a display device according to an embodiment of the disclosure in a side view; and

FIG. 10 is a schematic diagram of a product of a display device according to an embodiment of the disclosure.

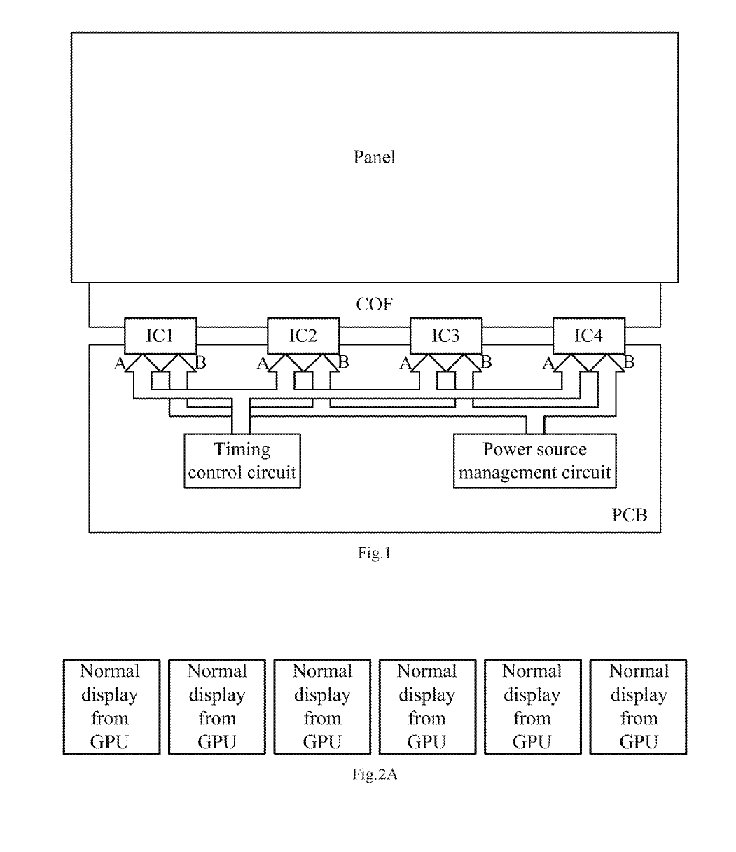

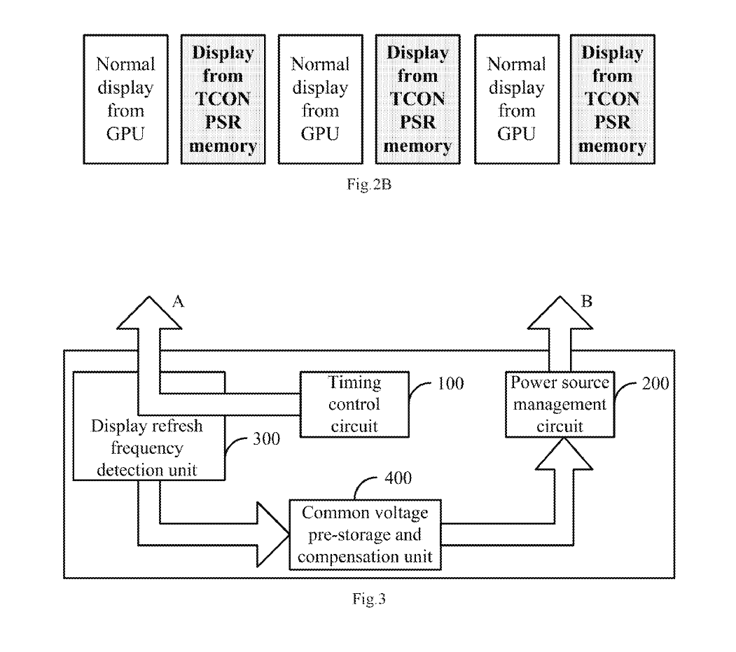

### DETAILED DESCRIPTION OF THE EMBODIMENTS

A display driver circuit board, a driving method thereof, and a display device according to embodiments of the disclosure will be described below in details with reference to the drawings.

As illustrated in FIG. 3, a display driver circuit board according to an embodiment of the disclosure can include a timing control circuit 100, a power source management circuit 200, a display refresh frequency detection unit 300, and a common voltage pre-storage and compensation unit 400, where:

The timing control circuit 100 is configured to output a frame start signal (STV) A at a preset display refresh frequency;

The display refresh frequency detection unit 300 is electrically connected with the timing control circuit 100 and the common voltage pre-storage and compensation unit 400, and configured to detect the display refresh frequency of the frame start signal A output by the timing control circuit 100, and to output the detected display refresh frequency to the common voltage pre-storage and compensation unit 400; and

The common voltage pre-storage and compensation unit 400 is electrically connected with the power source management circuit 200, and configured to determine common voltage corresponding to the display refresh frequency output by the display refresh frequency detection unit 300 according to a pre-stored correspondence relationship between respective display refresh frequencies and respective common voltages, and to control the power source management circuit 200 to output the common voltage (Vcom) B corresponding to the display refresh frequency.

In the display driver circuit board above according to the embodiment of the disclosure, the display refresh frequency detection unit 300 and the common voltage pre-storage and compensation unit 400 are added to the display driver circuit board in the related art. The additional display refresh frequency detection unit 300 can detect the display refresh frequency of the frame start signal A output by the timing control circuit 100, and output the detected display refresh frequency to the common voltage pre-storage and compensation unit 400, and thereafter the additional common voltage pre-storage and compensation unit 400 can determine the common voltage corresponding to the display refresh frequency output by the display refresh frequency detection unit 300 according to the pre-stored correspondence relationship between respective display refresh frequencies and respective common voltages, and control the power source management circuit 200 to output the common voltage (Vcom) B corresponding to the display refresh frequency, so that the display driver circuit board can adjust in real time the output common voltage B according to the varying display refresh frequency to thereby guarantee the output common voltage B to be the optimum common voltage matching the display refresh frequency, thus facilitating an improvement in stabilized uniformity of the display panel, and addressing a factor of flicker so as to improve the display quality of the display panel, and improve user experience.

In an implementation, in the display driver circuit board above according to the embodiment of the disclosure, in order to guarantee the reliability and stability of the respective elements in the display driver circuit board, the additional display refresh frequency detection unit 300 and common voltage pre-storage and compensation unit 400 can be separate from the original elements in the display driver circuit board, that is, the timing control circuit 100, the power source management circuit 200, the display refresh frequency detection unit 300, and the common voltage pre-storage and compensation unit 400 can be separate from each other in the display driver circuit board as illustrated in FIG. 3.

Alternatively in an implementation, in the display driver circuit board above according to the embodiment of the disclosure, in order to guarantee the integrity of the respective elements in the display driver circuit board, one of the additional display refresh frequency detection unit 300 and common voltage pre-storage and compensation unit 400 can be integrated in one of the original elements in the display driver circuit board.

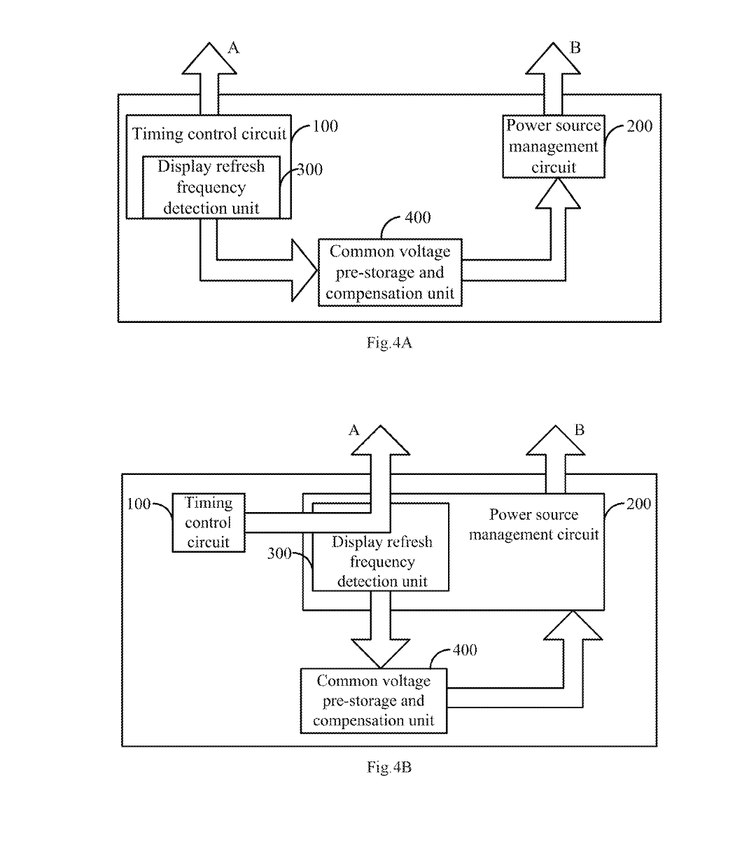

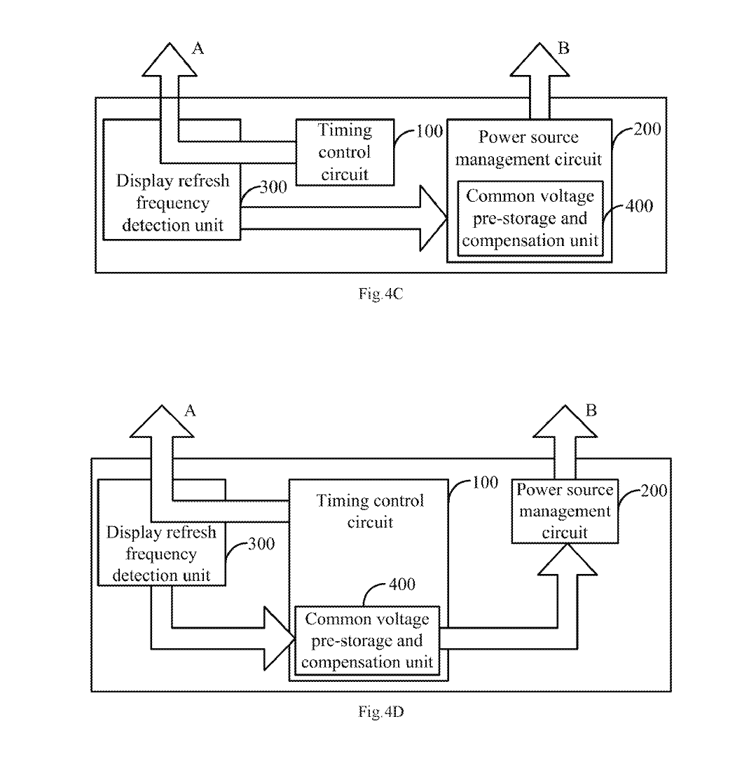

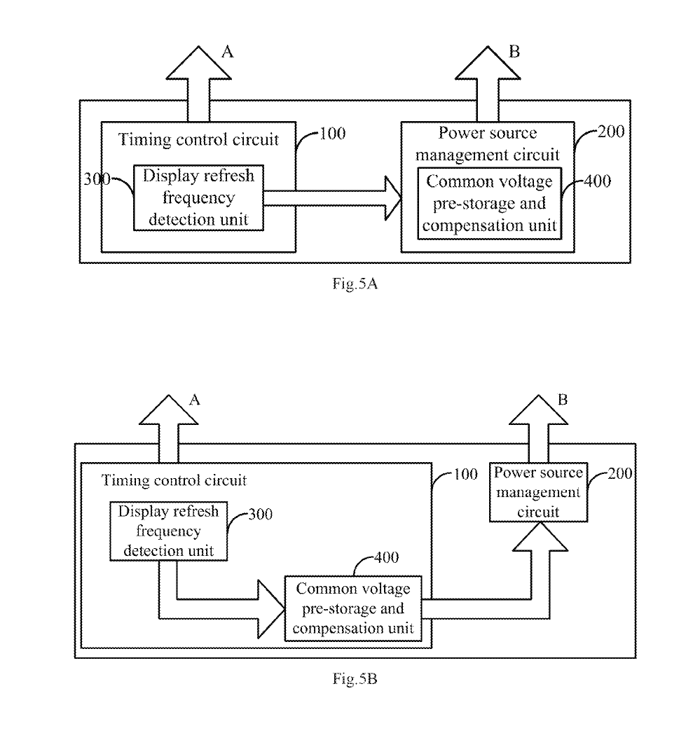

In an implementation, in the display driver circuit board above according to the embodiment of the disclosure, as illustrated in FIG. 4A, for example, the display refresh frequency detection unit 300 can be integrated in the timing control circuit 100 so that the timing control circuit 100 outputs the display refresh frequency directly to the common voltage pre-storage and compensation unit 400 while outputting the frame start signal A; or as illustrated in FIG. 4B, the display refresh frequency detection unit 300 can be integrated in the power source management circuit 200, although the embodiment of the disclosure will not be limited thereto.

In an implementation, in the display driver circuit board above according to the embodiment of the disclosure, as illustrated in FIG. 4C, the common voltage pre-storage and compensation unit 400 can be integrated in the power source management circuit 200 so that the power source management circuit 200 can output the corresponding common voltage directly upon reception of the display refresh frequency output by the display refresh frequency detection unit 300; or as illustrated in FIG. 4D, the common voltage pre-storage and compensation unit 400 can be integrated in the timing control circuit 100, although the embodiment of the disclosure will not be limited thereto.

Furthermore in an implementation, in the display driver circuit board above according to the embodiment of the disclosure, in order to guarantee the integrity of the respective elements in the display driver circuit board, both the additional display refresh frequency detection unit 300 and common voltage pre-storage and compensation unit 400 can be integrated in one of the original elements in the display driver circuit board.

In an implementation, in the display driver circuit board above according to the embodiment of the disclosure, as illustrated in FIG. 5A, for example, the display refresh frequency detection unit 300 can be integrated in the timing control circuit 100, and also the common voltage pre-storage and compensation unit 400 can be integrated in the power source management circuit 200, so that the timing control circuit 100 outputs the display refresh frequency directly to the power source management circuit 200 while outputting the frame start signal A, and the power source management circuit 200 can output the corresponding common voltage directly upon reception of the display refresh frequency; or as illustrated in FIG. 5B, both the display refresh frequency detection unit 300 and the common voltage pre-storage and compensation unit 400 can be integrated in the timing control circuit 100 so that the timing control circuit 100 controls the power source management circuit 200 directly to output the corresponding common voltage while outputting the frame start signal A; or as illustrated in FIG. 5C, both the display refresh frequency detection unit 300 and the common voltage pre-storage and compensation unit 400 can be integrated in the power source management circuit 200 so that the power source management circuit 200 outputs the corresponding common voltage directly upon detection of the display refresh frequency of the frame start signal A, although the embodiment of the disclosure will not be limited thereto.

In an implementation, in the display driver circuit board above according to the embodiment of the disclosure, the correspondence relationship between respective display refresh frequencies and respective common voltages pre-stored in the common voltage pre-storage and compensation unit 400 is a predetermined correspondence relationship between a plurality of possible display refresh frequencies of the frame start signal A, and their corresponding optimum common voltages, where the optimum common voltage refers to such common voltage at the display refresh frequency that enable the driven display plane to flicker the least. For example, the start frame signal A output by the timing control circuit 100 may be output at four display refresh frequencies of 70 Hz, 60 Hz, 50 Hz, and 40 Hz. At this time, listed common voltages corresponding to these display refresh frequencies respectively are as depicted in Table 1 below. As can be apparent, typically the common voltage is lower at a higher display refresh frequency.

TABLE 1

| | | | | | | | |
|---|---|---|---|---|---|---|---|
| Frequency (Hz) | 70 | — | 60 | — | 50 | — | 40 |
| Common voltage (V) | 3 | — | 3.3 | — | 3.5 | — | 3.8 |

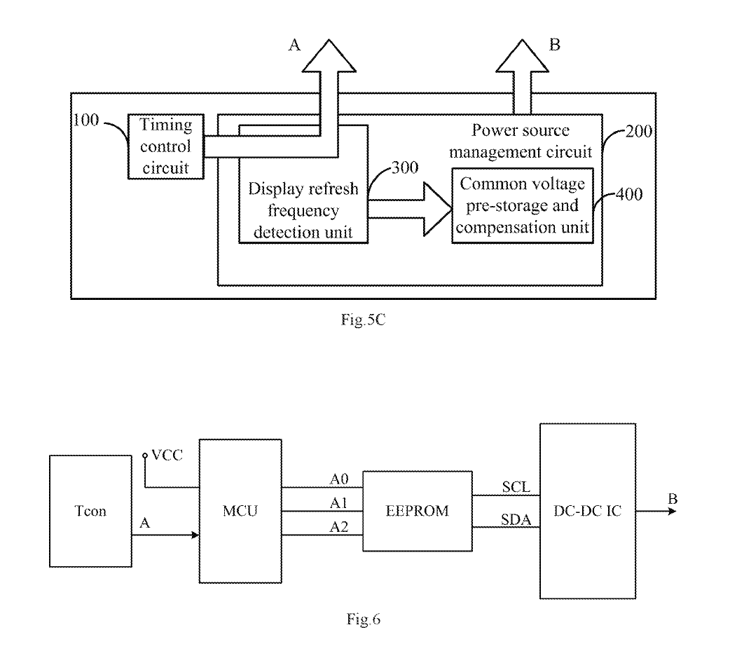

In an implementation, in the display driver circuit board above according to the embodiment of the disclosure, as illustrated in FIG. 6, the display refresh frequency detection unit 300 can be embodied as a monolithic processor MCU to perform the functions thereof, and the common voltage pre-storage and compensation unit 400 can be embodied as an Electrically Erasable Programmable Read Only Memory (EEPROM) to perform the functions thereof.

Based upon the same inventive idea, an embodiment of the disclosure further provides a driving method of a display driver circuit board, and since the method addresses the problem under a similar principle to the display driver circuit board above, reference can be made to the implementation of the display driver circuit board above for an implementation of the method, so a repeated description thereof will be omitted here.

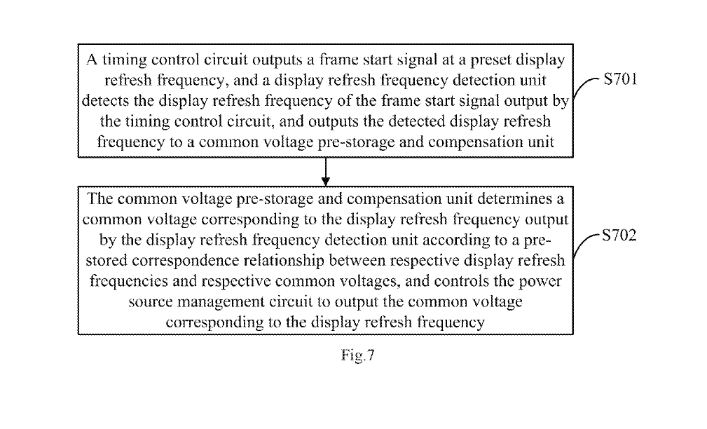

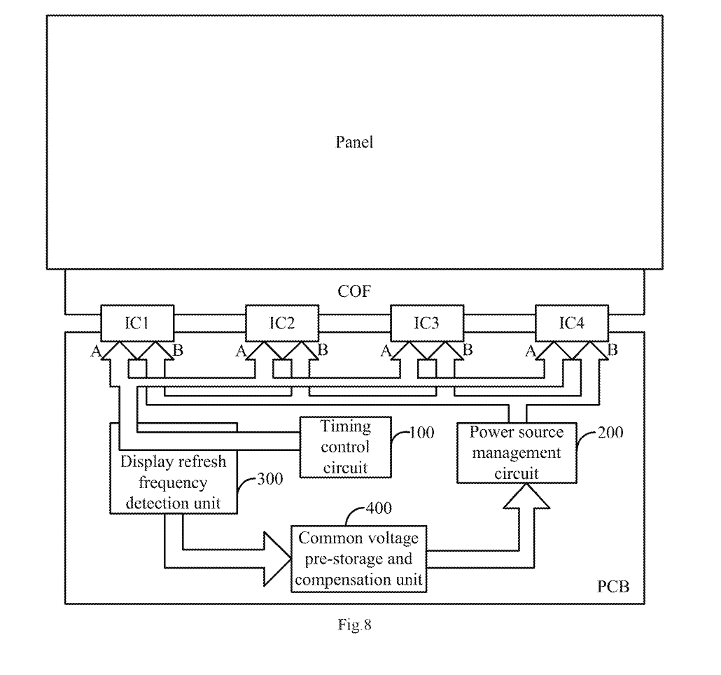

An embodiment of the disclosure provides a driving method of a display driver circuit board as illustrated in FIG. 7, where the method includes the following steps:

In the step S701, a timing control circuit outputs a frame start signal at a preset display refresh frequency, and a display refresh frequency detection unit detects the display refresh frequency of the frame start signal output by the timing control circuit, and outputs the detected display refresh frequency to a common voltage pre-storage and compensation unit; and

In the step S702, the common voltage pre-storage and compensation unit determines common voltage corresponding to the display refresh frequency output by the display refresh frequency detection unit according to a pre-stored correspondence relationship between respective display refresh frequencies and respective common voltages, and controls the power source management circuit to output the common voltage corresponding to the display refresh frequency.

In the driving method above of a display driver circuit board according to the embodiment of the disclosure, the display refresh frequency detection unit can detect the display refresh frequency of the frame start signal output by the timing control circuit, and output the detected display refresh frequency to the common voltage pre-storage and compensation unit, and thereafter the common voltage pre-storage and compensation unit can determine the common voltage corresponding to the display refresh frequency output by the display refresh frequency detection unit according to the pre-stored correspondence relationship between respective display refresh frequencies and respective common voltages, and control the power source management circuit to output the common voltage corresponding to the display refresh frequency, so that the display driver circuit board can adjust in real time the output common voltage according to the varying display refresh frequency to thereby guarantee the output common voltage to be the optimum common voltage matching the display refresh frequency, thus facilitating an improvement in stabilized uniformity of the display panel, and addressing a factor of flicker so as to improve the display quality of the display panel, and improve user experience.

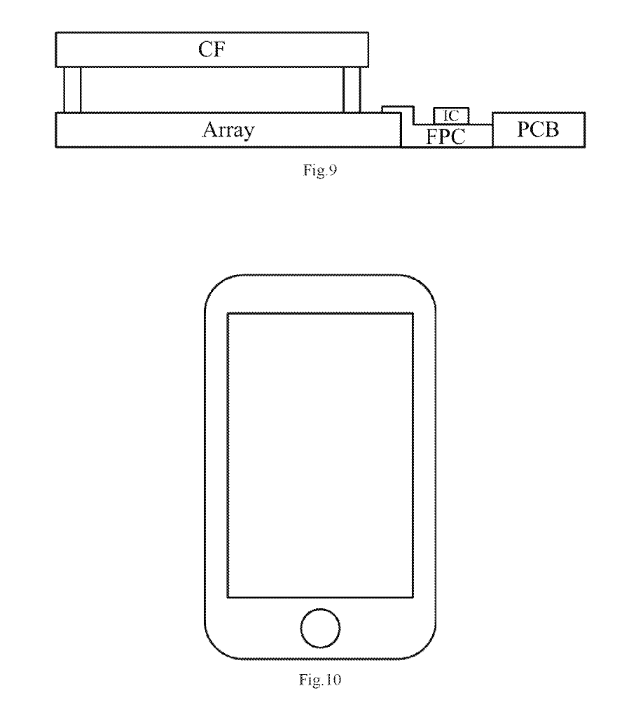

Based upon the same inventive idea, an embodiment of the disclosure further provides a display device as illustrated in FIG. 8 and FIG. 9, which includes a display panel, and the display driver circuit board PCB according to any one of the embodiments above of the disclosure, connected with the display panel. The display device can be a mobile phone as illustrated in FIG. 10, a tablet computer, a TV set, a display, a notebook computer, a digital photo frame, a navigator, and any other product or component capable of displaying. Reference can be made to the embodiments of the display driver circuit board above for an implementation of the display device, so a repeated description thereof will be omitted here.

In the display device above according to the embodiment of the disclosure, the display refresh frequency detection unit and the common voltage pre-storage and compensation unit are added to the display driver circuit board, so that the display refresh frequency detection unit can detect the display refresh frequency of the frame start signal output by the timing control circuit, and output the detected display refresh frequency to the common voltage pre-storage and compensation unit, and thereafter the common voltage pre-storage and compensation unit can determine the common voltage corresponding to the display refresh frequency output by the display refresh frequency detection unit according to the pre-stored correspondence relationship between respective display refresh frequencies and respective common voltages, and control the power source management circuit to output the common voltage corresponding to the display refresh frequency, so that the display driver circuit board can adjust in real time the output common voltage according to the varying display refresh frequency to thereby guarantee the output common voltage to be the optimum common voltage matching the display refresh frequency, thus facilitating an improvement in stabilized uniformity of the display panel, and addressing a factor of flicker so as to improve the display quality of the display panel, and improve user experience.

In the display device above according to the embodiment of the disclosure, the display panel can be a liquid crystal display panel, an organic electroluminescent display panel, a plasma display panel, etc. The display panel may be a rigid display panel or may be a flexible display panel, although the embodiment of the disclosure will not be limited thereto.

In the display device above according to the embodiment of the disclosure, if the display panel is a liquid crystal display panel, then the liquid crystal display panel may generally include an array substrate and a color filter substrate arranged opposite to each other, and as illustrated in FIG. 8 and FIG. 9, the liquid crystal display panel may further include a plurality of source driver chips IC1, IC2, IC3, and IC4 bound on an edge frame of the display panel by a Chip On Film (COF). The respective source driver chips IC1, IC2, IC3, and IC4 are typically bound on an edge frame of the array substrate of the display panel by a Chip On Film (COF). The source driver chips IC1, IC2, IC3, and IC4 are configured to receive the frame start signal output by the timing control circuit 100 in the display driver circuit board PCB at the preset display refresh frequency, and to receive the common voltage, corresponding to the display refresh frequency, output by the power source management circuit 200.

In the display driver circuit board, the driving method of the same, and the display device according to the embodiments of the disclosure, the display refresh frequency detection unit and the common voltage pre-storage and compensation unit are added to the display driver circuit board, so that the display refresh frequency detection unit can detect the display refresh frequency of the frame start signal output by the timing control circuit, and output the detected display refresh frequency to the common voltage pre-storage and compensation unit, and thereafter the common voltage pre-storage and compensation unit can determine the common voltage corresponding to the display refresh frequency output by the display refresh frequency detection unit according to the pre-stored correspondence relationship between respective display refresh frequencies and respective common voltages, and control the power source management circuit to output the common voltage corresponding to the display refresh frequency, so that the display driver circuit board can adjust in real time the output common voltage according to the varying display refresh frequency to thereby guarantee the output common voltage to be the optimum common voltage matching the display refresh frequency, thus facilitating an improvement in stabilized uniformity of the display panel, and addressing a factor of flicker so as to improve the display quality of the display panel, and improve user experience.

Evidently those skilled in the art can make various modifications and variations to the disclosure without departing from the spirit and scope of the disclosure. Accordingly the disclosure is also intended to encompass these modifications and variations thereto so long as the modifications and variations come into the scope of the claims appended to the disclosure and their equivalents.

1. A display driver circuit board, comprising:
a timing control circuit;
a power source management circuit;
a display refresh frequency detection unit; and
a common voltage pre-storage and compensation unit, wherein:
the timing control circuit is configured to output a frame start signal at a preset display refresh frequency;
the display refresh frequency detection unit is electrically connected with the timing control circuit, the common voltage pre-storage and compensation unit, and configured to detect the display refresh frequency of the frame start signal output by the timing control circuit, and to output the detected display refresh frequency to the common voltage pre-storage and compensation unit; and
the common voltage pre-storage and compensation unit is electrically connected with the power source management circuit, and configured to determine common voltage corresponding to the display refresh frequency output by the display refresh frequency detection unit according to a pre-stored correspondence relationship between respective display refresh frequencies and respective common voltages, and to control the power source management circuit to output the common voltage corresponding to the display refresh frequency.

2. The display driver circuit board according to claim 1, wherein the display refresh frequency detection unit is integrated in the timing control circuit.

3. The display driver circuit board according to claim 1, wherein the display refresh frequency detection unit is integrated in the power source management circuit.

4. The display driver circuit board according to claim 1, wherein the common voltage pre-storage and compensation unit is integrated in the power source management circuit.

5. The display driver circuit board according to claim 2, wherein the common voltage pre-storage and compensation unit is integrated in the power source management circuit.

6. The display driver circuit board according to claim 3, wherein the common voltage pre-storage and compensation unit is integrated in the power source management circuit.

7. The display driver circuit board according to claim 1, wherein the common voltage pre-storage and compensation unit is integrated in the timing control circuit.

8. The display driver circuit board according to claim 2, wherein the common voltage pre-storage and compensation unit is integrated in the timing control circuit.

9. The display driver circuit board according to claim 3, wherein the common voltage pre-storage and compensation unit is integrated in the timing control circuit.

10. The display driver circuit board according to claim 1, wherein the correspondence relationship between respective display refresh frequencies and respective common voltages pre-stored in the common voltage pre-storage and compensation unit is that the common voltage is lower at a higher display refresh frequency.

11. A display device, comprising:
a display panel; and
a display driver circuit board connected with the display panel, wherein the display driver circuit board comprises:
a timing control circuit,
a power source management circuit,
a display refresh frequency detection unit, and
a common voltage pre-storage and compensation unit, wherein:
the timing control circuit is configured to output a frame start signal at a preset display refresh frequency;
the display refresh frequency detection unit is electrically connected with the timing control circuit and the common voltage pre-storage and compensation unit, and configured to detect the display refresh frequency of the frame start signal output by the timing control circuit, and to output the detected display refresh frequency to the common voltage pre-storage and compensation unit; and
the common voltage pre-storage and compensation unit is electrically connected with the power source management circuit, and configured to determine common voltage corresponding to the display refresh frequency output by the display refresh frequency detection unit according to a pre-stored correspondence relationship between respective display refresh frequencies and respective common voltages, and to control the power source management circuit to output the common voltage corresponding to the display refresh frequency.

12. The display device according to claim 11, wherein the display refresh frequency detection unit is integrated in the timing control circuit.

13. The display device according to claim 11, wherein the display refresh frequency detection unit is integrated in the power source management circuit.

14. The display device according to claim 11, wherein the common voltage pre-storage and compensation unit is integrated in the power source management circuit.

15. The display device according to claim 11, wherein the common voltage pre-storage and compensation unit is integrated in the timing control circuit.

16. The display device according to claim 11, wherein the correspondence relationship between respective display refresh frequencies and respective common voltages pre-stored in the common voltage pre-storage and compensation unit is that the common voltage is lower at a higher display refresh frequency.

17. The display device according to claim 11, wherein the display device is a liquid crystal display panel.

18. The display device according to claim 11, wherein the display device further comprises a plurality of source driver chips bound on an edge frame of the display panel by a chip on film; and
the source driver chips are configured to receive the frame start signal output by the timing control circuit in the display driver circuit board at the preset display refresh frequency, and to receive the common voltage, corresponding to the display refresh frequency, output by the power source management circuit.

19. A driving method of a display driver circuit board, the method comprising:
outputting, by a timing control circuit, a frame start signal at a preset display refresh frequency, and detecting, by a display refresh frequency detection unit, the display refresh frequency of the frame start signal output by the timing control circuit, and outputting the detected display refresh frequency to a common voltage pre-storage and compensation unit; and
determining, by the common voltage pre-storage and compensation unit, a common voltage corresponding to the display refresh frequency output by the display refresh frequency detection unit according to a pre-stored correspondence relationship between respective display refresh frequencies and respective common voltages, and controlling the power source management circuit to output the common voltage corresponding to the display refresh frequency.
